(19) United States
(12) Patent Application Publication
(10) Pub. No.: US 2019/0110430 A1
(43) Pub. Date: Apr. 18, 2019

(54) MOBILE ANIMAL SHELTER DEVICE

(71) Applicant: Daniel Badiou, Notre Dame des Lourdes (CA)

(72) Inventor: Daniel Badiou, Notre Dame des Lourdes (CA)

(21) Appl. No.: 16/094,604

(22) PCT Filed: Mar. 31, 2017
(86) PCT No.: PCT/CA2017/050392

§ 371 Date: Oct. 18, 2018

Related U.S. Application Data
(60) Provisional application No. 62/446,641, filed on Jan. 16, 2017.
(60) Provisional application No. 62/325,569, filed on Apr. 21, 2016.

(51) Int. Cl. A01K 1/00; A01K 1/03; A01K 31/18; A01K 5/02; A01K 39/012

(52) U.S. Cl. CPC A01K 1/0035; A01K 1/032; G05D 1/021; A01K 5/0275; A01K 39/012; A01K 31/18

(57) ABSTRACT

A mobile animal shelter device forms an enclosure for containing animals therein having an open bottom which is open to the ground surface. The device is supported on wheels which are controllably driven by a controller which displaces the shelter device across the ground according to programmed conditions which can be adjusted by the operator. Various panels of the housing may be opened and closed, feed can be controllably dispensed, and various other conditions can be automatically controlled in response to prescribed criteria by the controller. A lower skirt portion about a perimeter of the opening in the bottom of the enclosure is flexible so as to vary in elevational according to ground contours.

### FIELD OF THE INVENTION

The present invention relates to a shelter device having an open bottom for housing animals therein, for example poultry or small mammals such as rabbits, such that the animals have open access to a prescribed patch of grassy ground, and more particularly the present invention relates to an animal shelter device having an open bottom which is supported on wheels to periodically relocate the animal shelter device across the ground to a fresh path of grassy ground.

### BACKGROUND

When raising various types of animals, for example free range chickens, or rabbits, it is known to be desirable to relocate the animals to a fresh patch of grass periodically which is free of animal waste and provides new grass for feeding. Various chicken enclosures are known which can be manually relocated across a field and are generally referred to as chicken tractors. The typical structure of a chicken tractor is in the form of a chicken coop with no floor so that the animals contained therein have access to the ground through the open bottom. Smaller sized enclosures can be manually relocated across the ground simply by dragging. In other instances, wheels are provided onto which one or both ends of the enclosure is manually lifted. When wheels are provided at only one end, a user typically lifts the other end to displace across the ground in a manner similarly to a conventional wheelbarrow. The operation and maintenance of a chicken tractor can be a laborious task which typically requires daily attention by the operator.

### SUMMARY OF THE INVENTION

According to one aspect of the invention there is provided a mobile animal shelter device for movement across a ground surface, the device comprising:

a frame defining an enclosure having walls and a roof surrounding a hollow interior of the enclosure which is arranged for containing animals therein, and an open bottom such that the hollow interior of the enclosure is open to the ground surface;

a plurality of transport wheels supporting the frame thereon such that the frame is supported for rolling movement across the ground surface;

a motor operatively connected to the transport wheels for driving the transport wheels; and

a controller operatively connected to the motor so as to be arranged to displace the frame across the ground surface by a controlled amount prescribed by the controller.

The controller may include a timer configured to actuate the motor at selected times for a controlled duration to effect movement of the frame across the ground surface by said controlled amount, and/or a GPS device in communication with the controller such that the controller is configured to effect movement of the frame across the ground surface by said controlled amount using GPS information from the GPS device.

By providing wheels which are operatively connected to a motor and a respective controller, the enclosure can be relocated to a fresh patch of grassy ground by various control means including automated displacement according to a scheduled timer, or operation by remote control means. The presence of a controller also readily allows automation and control of various other functions on the animal shelter device, including automated feeding of the animals, and automated reconfiguration of the shelter device according to environmental conditions for example.

When the transport wheels are steerable about respective upright axes relative to the frame, and there is provided a steering actuator arranged to steer the transport wheels relative to the frame about their respective upright axes, the controller is preferably operatively connected to the steering actuator so as to be arranged to steer the transport wheels by a controlled amount as the frame is displaced across the ground surface.

The device may be used in combination with a central server at a remote location relative to the device in which the controller includes a transceiver adapted to communicate with the central server over a wireless network such that the controller is operable to displace the frame across the ground by said controlled amount in response to an instruction received from the central server.

The device may be used with a personal computer device adapted to communicate with the central server over a wireless network such that the computer device is arranged to receive feedback information from the controller through the central server and the controller is arranged to receive instructions from the computer device through the central server. The feedback information may include a water level sensed by a water dispenser sensor on the frame, a feed level sensed by a feeder sensor on the frame, a humidity level sensed by a humidity sensor on the frame, a temperature sensed by a temperature sensor on the frame, a wind speed sensed by a wind sensor on the frame, a video captured by a camera on the frame, or any combination thereof.

The device may further include (i) at least one body panel which is pivotally supported on the frame so as to be operable between a closed position covering a respective boundary portion of the enclosure and an open position in which the respective boundary portion is at least partially unobstructed by the body panel and (ii) a panel actuator connected to said at least one body panel, in which the controller is operatively connected to the panel actuator so as to be arranged to actuate opening and closing of said at least one body panel. In some embodiments, the controller is arranged to displace said at least one body panel responsive to a sensed environmental condition as sensed by a sensor on the frame.

When using a central server at a remote location relative to the device and the controller includes a transceiver adapted to communicate with the central server over a wireless network, the controller may be arranged to displace said at least one body panel responsive to an instruction received by the controller from the central server over the wireless network.

When there is provided a feed supply and a feeder supported on the frame, the controller may be operatively connected to the feeder so as to be arranged to dispense a controlled amount of feed from the feed supply into the enclosure.

The device may include a lower skirt portion supported at a bottom end of the walls of the frame to extend fully about a perimeter of the frame, in which the lower skirt portion is movable relative to the transport wheels between a transport position in which the skirt portion is spaced above the ground surface and a stationary position in which the skirt portion is engaged with the ground surface. When the frame is fixed in elevation relative to the transport wheels, the skirt portion is preferably movable relative to the frame between the transport position and the stationary position. In this instance, a plurality of skirt actuators may be coupled between the frame and the skirt portion at spaced apart positions about the perimeter of frame, in which the skirt actuators are operatively connected to the controller so as to be operable to displace the skirt portion between the transport and stationary positions under control of the controller. The skirt portion may be resiliently supported relative to the skirt actuators, and may be flexible so as to be arranged to deflect about varying ground contours.

According to a second aspect of the present invention there is provided a mobile animal shelter device for movement across a ground surface, the device comprising:

a frame defining an enclosure having walls and a roof surrounding a hollow interior of the enclosure which is arranged for containing animals therein, and an open bottom such that the hollow interior of the enclosure is open to the ground surface;

a plurality of transport wheels supporting the frame thereon such that the frame is supported for rolling movement across the ground surface;

a motor operatively connected to the transport wheels for driving the transport wheels; and

a lower skirt portion supported at a bottom end of the walls of the frame to extend fully about a perimeter of the frame, the lower skirt portion being movable relative to the transport wheels between a transport position in which the skirt portion is spaced above the ground surface and a stationary position in which the skirt portion is engaged with the ground surface.

The frame may be fixed in elevation relative to the transport wheels such that the skirt portion is movable relative to the frame between the transport position and the stationary position. Preferably a plurality of skirt actuators are coupled between the frame and the skirt portion at spaced apart positions about the perimeter of frame so as to be operable to displace the skirt portion between the transport and stationary positions under control of an controller.

Preferably the skirt portion is resiliently supported relative to the skirt actuators. In further embodiments, the skirt portion may be flexible or include a lower flexible portion so as to be arranged to deflect about varying ground contours.

According to a third aspect of the present invention there is provided a mobile animal shelter device for movement across a ground surface, the device comprising:

a frame defining an enclosure having walls and a roof surrounding a hollow interior of the enclosure which is arranged for containing animals therein, and an open bottom such that the hollow interior of the enclosure is open to the ground surface;

a plurality of transport wheels supporting the frame thereon such that the frame is supported for rolling movement across the ground surface;

a motor operatively connected to the transport wheels for driving the transport wheels;

at least one body panel which is pivotally supported on the frame so as to be operable between a closed position covering a respective boundary portion of the enclosure and an open position in which the respective boundary portion is at least partially unobstructed by the body panel;

a panel actuator connected to said at least one body panel; and

a controller operatively connected to the panel actuator so as to be arranged to actuate opening and closing of said at least one body panel.

The controller may be arranged to displace said at least one body panel responsive to a sensed environmental condition as sensed by a sensor on the frame.

Alternatively, when a central server is provided at a remote location relative to the device, the controller may include a transceiver adapted to communicate with the central server over a wireless network such that the controller is arranged to displace said at least one body panel responsive to an instruction received by the controller from the central server over the wireless network.

According to a further aspect of the present invention there is provided a mobile animal shelter device for movement across a ground surface, the device comprising:

a main frame defining an enclosure having walls and a roof surrounding a hollow interior of the enclosure which is arranged for containing animals therein, and an open bottom such that the hollow interior of the enclosure is open to the ground surface;

a plurality of transport wheels supporting the main frame thereon such that the main frame is supported for rolling movement across the ground surface;

a motor operatively connected to the transport wheels for driving the transport wheels; and

a lower skirt portion supported at a bottom end of the walls of the main frame to extend downwardly to a bottom end of the lower skirt portion for engaging the ground about a full perimeter of the main frame;

the lower skirt portion comprising a plurality of skirt elements, each having a lower ground engaging surface defining a respective portion of the bottom end of the lower skirt portion and being supported for individual displacement relative to the main frame such that the bottom end of the lower skirt portion is flexible so as to vary in elevational according to ground contours.

Each skirt element is preferably biased downwardly for engagement against the ground, for example by gravity or using a spring biasing member.

Preferably each skirt element comprises a skid plate defining the lower ground engaging surface for engagement against the ground. The skid plate may include (i) a ramp surface protruding outwardly from opposing edges of the skid plate at an upward slope, and/or (ii) a linkage coupled between the skid plate and the main frame for supporting the skid plate to vary in elevational relative the main frame such that the skid plate is pivotal relative to the linkage about a generally horizontal axis.

More particularly, each skirt element may comprise a linkage member pivotally supported at a top end relative to the main frame and extending downwardly at a slop to a bottom end supporting the lower ground engaging surface therein such that pivotal movement of the linkage member varies an elevation of the lower ground engaging surface relative to the main frame.

The device may further include at least one flexible member interconnecting adjacent ones of the skirt elements such that some changes in elevation of one of the skirt elements will change elevational of the adjacent skirt elements.

A lift assembly may be coupled between said at least one flexible member and the main frame so as to be arranged to commonly lift all of the skirt elements relative to the main frame.

Alternatively, a supporting frame assembly may support the skirt elements on the main frame, such that a lift assembly may be coupled between the supporting frame assembly and the main frame so as to be arranged to commonly lift all of the skirt elements relative to the main frame.

### BRIEF DESCRIPTION OF THE DRAWINGS

Various embodiments of the invention will now be described in conjunction with the accompanying drawings in which:

FIG. 1 is a perspective view of the animal shelter device;

FIG. 2 is an end elevational view of the animal shelter device;

FIG. 3 is a top plan view of the animal shelter device;

FIG. 4 is a side elevational view of the animal shelter device;

FIG. 5 is a perspective view of the opposing end of the animal shelter device relative to FIG. 1;

FIG. 6 is a schematic representation of the communication between the controller of the animal shelter device and a personal computer device of a user communicating through a central server over a wireless network;

FIG. 7 is a perspective view of an alternative embodiment of the skirt portion;

FIG. 8 is a partly sectional view of one element of the skirt portion according to FIG. 7;

FIG. 9 is a perspective view of a further embodiment of the animal shelter device;

FIG. 10 is another perspective view of the animal shelter device according to the embodiment of FIG. 9;

FIGS. 11 and 12 are perspective views of one of the skirt elements of the animal shelter device according to the embodiment of FIG. 9;

FIGS. 13 and 14 are side elevation and end elevational views of the skirt element according to FIGS. 11 and 12 in a neutral position; and

FIG. 15 is a perspective view of another one of the skirt elements of the animal shelter device according to the embodiment of FIG. 9.

In the drawings like characters of reference indicate corresponding parts in the different figures.

### DETAILED DESCRIPTION

Referring to the accompanying figures there is illustrated a mobile animal shelter device generally indicated by reference numeral 10. The device 10 is particularly suited for sheltering animals therein such that the animals have access to a ground surface having grass thereon.

The device 10 includes a frame which generally defines an enclosure about a hollow interior of the shelter device. The frame is elongate in a longitudinal direction, having two sides 12 extending longitudinally along opposing sides of the frame between two opposing ends 14. The frame is thus generally rectangular in shape so as to define four wall portions 16 and a roof portion 18 connected between the top ends of the wall portions 16 which form a rectangular perimeter about the hollow interior. Each wall portion is defined by a respective header beam 20 along the top end thereof and a footer beam 22 along the bottom end thereof. A plurality of posts 24 are connected vertically between the header beam and the footer beam at spaced positions along the wall and at opposing ends thereof.

The openings between adjacent post 24 are provided with mesh material spanning thereacross, for example chicken wire and the like. The wall portions are joined together such that four of the posts 24 define respective corner posts of the rectangular frame and such that the header and footer beams collectively define a perimeter header and a perimeter footer of the overall frame structure.

An inner skirt member 25 is mounted along the inside surface of the walls about a full perimeter of the frame. The inner skirt member 25 is a vertically oriented panel, which is fixed relative to the frame and which is generally annular to extend about a full perimeter of the frame. The skirt member includes straight sections along the main portion of each wall portion, and a curved section at each of the four corners between the straight sections to avoid the animals from crowding in the corners of the shelter device.

One or more wall portions may be provided with a door frame incorporated therein which can be opened and closed for providing access of persons into the interior of the enclosure for tending to animals contained therein.

The bottom side of the frame remains open such that animals contained in the hollow interior have full access to the ground surface therebelow.

The roof portion 18 includes a main section fully spanning laterally between the header beams at opposing sides of the frame and fully spanning longitudinally between the header beams at the opposing ends of the frame. The main section is supported at a downward slope from one side to the opposing side of the frame in the lateral direction such that the main portion of the roof lies within a single common plane. The header beams at the opposing end walls are sloped similarly to the roof panel supported thereon such that the corner posts 24 have different heights relative to one another.

The main portion of the roof includes a roof frame which supports canvas material spanning within the plane of the roof. The canvas material is double sided, so as to include a black side and a white side which absorb solar heat by different amounts. The canvas is turned to having the black facing the outside during the colder months of the year and the white facing the outside for the warmer months.

The roof also includes two auxiliary body panels 26 connected to the main section. The two body panels 26 are hinged at the laterally opposing sides of the main section of the roof portion such that the body panels span the full length of the frame in the longitudinal direction and are pivotal about respective longitudinally oriented pivot axes. Each body panel is pivotal between i) a closed position extending vertically downward against a corresponding portion of the adjacent wall of the frame such that a corresponding opening of the wall associated with the body panel is closed by the panel, and ii) an open position in which the body panel extends laterally outwardly away from the opposing body panel at a slight downward slope so that the corresponding wall opening therebelow is substantially unobstructed by the body panel and the body panel provides the function of an awning.

A panel actuator 28 is associated with each body panel and is coupled between the frame and the body panel to actuate the body panel between the open and closed positions thereof. The panel actuator may be an electric linear actuator for example.

To displace the frame across the ground for access of the hollow interior to a fresh patch of ground, a plurality of transport wheels 30 are provided which support the frame for rolling movement across the ground.

To support the frame relative to the wheels, a longitudinal beam 32 is provided which extends along each of the longitudinally extending sides of the frame to be joined to the posts of the wall portion at a location spaced upwardly from a bottom end of the wall portion. An inner crossbar 34 is connected between the two longitudinal beams 32 at each of the two opposing ends of the frame so as to be joined to the posts of the corresponding end walls of the frame. The longitudinal beams 32 are sized to protrude longitudinally outward beyond the inner crossbar at both ends for supporting the transport wheels relative to the beam at respective ends of the beams spaced longitudinally outward beyond the ends of the end walls of the frame.

An outer crossbar 36 is provided at both ends of the frame at a location which is parallel and spaced longitudinally outward relative to the respective inner crossbar 34. At a first end of the frame, the auxiliary crossbar 36 spans the full lateral width of the frame so as to be connected between the ends of the two longitudinal beams 32.

A cradle 38 is mounted between the inner and outer crossbars at the first end of the frame for supporting a water tank 40 therein which supplies water to a water dispenser of the device. A suitable water actuator 42 actuates the water dispenser to dispense water from the tank to a feeding location within the enclosure such as a trough or a feeding nipple for example.

At an opposing second end of the frame, the outer crossbar 36 spans laterally inwardly from the end of one beam only part way across the lateral width of the frame for connection to an intermediate frame member 44 which extends in the longitudinal direction between the inner crossbar 36 and the inner end of the corresponding outer crossbar 36.

A feed supply tank 46 is mounted between the inner and outer crossbars at the second end of the frame which supplies feed to a feed dispenser of the device 10. A suitable feed actuator 48 controls the feed dispenser to dispense a controlled amount of feed from the feed supply tank 46 to a plurality of feed stations 50 at longitudinally spaced apart locations within the interior of the enclosure. A feed auger 51 typically conveys the feed from the feed supply tank to the feed stations where a suitable trough structure is provided from which the animals in the enclosure can feed.

Each transport wheel 30 is supported at a respective end of a respective one of the longitudinal beams 32 so as to be pivotal about a vertical steering axis extending through the central rolling axis of the wheel. More particularly each transport wheel is supported for rolling movement about a horizontal rolling axis on a respective fork frame 52 in which the fork frame is in turn pivotally coupled to the beam 32 for steering a movement about the vertical steering axis. A wheel actuator 54 in the form of an electric rotary motor operatively connected to the hub of each wheel for driving rotation of the wheel such that all of the wheel actuators 54 collectively define a drive motor for displacing the frame across the ground.

Each wheel further includes a crank member 56 mounted at the top end of the fork frame 52 so as to be pivotal relative to the main frame with the respective wheel about the vertical steering axis. A steering link arm 58 is associated with the pair of wheels at each end of the frame such that each steering link arm is connects the two associated wheels for pivotal movement together about their respective axis. A steering actuator 60 is provided at each end of the frame by being mounted operatively between the frame and a portion of the crank member 56 of one of the wheels. The steering actuator 60 is an electric linear actuator oriented such that extension and retraction of the steering actuator displaces the both crank members 56 and the steering link arm 58 connected therebetween in a manner to steer the two associated transport wheels together about their respective steering axes.

Typically, both steering actuators 60 are operated so that all four wheels are steered in the same direction at all times. The ensures that the shelter device moves across the ground to always make square movements, that is translations that are longitudinal and lateral relative to the frame. This way, all of the walls are moving at the same rate, decreasing the confusion and stress to the animals within the enclosure.

The longitudinal beams support the frame relative to the wheels such that the footer members forming a bottom perimeter edge of the main frame portion is supported spaced above the ground surface upon which the transport wheels are engaged for rolling movement. The clearance gap between the bottom edge of the fixed wall portions of the frame and the ground accommodate for various ground contours as the frame is displaced for rolling movement across the ground.

The clearance gap between the bottom perimeter edge of the main frame portion and the ground is selectively enclosed by a skirt portion 62 comprising a vertical wall portion having a height which is greater than the clearance gap which extends about the full perimeter of the main frame portion including both sides 12 and both ends 14 of the frame. The skirt portion is supported for a vertical sliding movement relative to the main frame between a transport position in which a bottom edge of the skirt portion is spaced upwardly from the ground in proximity to the bottom edge of the main frame portion, and a stationary position in which the skirt portion is lowered relative to the transport position such that the bottom edge of the skirt portion engages the ground and the vertical wall portion of the skirt substantially spans across and closes the clearance gap between the bottom edge of the main frame and the ground.

Even when the skirt portion is in the raised transport position, the clearance gap between the bottom of the frame and the ground is at least partially obstructed by a strip brush (not shown). The strip brush comprises a row of flexible bristles mounted in close proximity to one another to extend downwardly in relation to the bottom edge of the frame to collectively form a flexible wall extending about a full perimeter of the frame. The strip brush is mounted in fixed relation to a bottom edge of the inner skirt member 25.

The skirt portion 62 is supported for movement between the transport and stationary positions by four skirt actuators 64 which are mounted alongside the four corner posts 24 of the main frame. The actuators each comprise an electrically driven linear actuator which is vertically oriented. The skirt actuators 64 are coupled between the main frame portion and the skirt portion such that extension and retraction of the skirt actuators together causes the skirt portion 62 to be raised and lowered relative to the main frame portion.

A helical spring 66 is mounted for axial compression between each skirt actuator 64 and the skirt portion. The overall range of movement of the skirt actuator is arranged such that displacement of the actuators into the transport position causes the skirt portion to be sufficiently raised to provide a suitable clearance gap between the skirt portion and the ground for rolling movement of the frame across the ground. As the actuators are actuated to lower the skirt portion towards the stationary position, the range of movement of the actuators is arranged to compress the springs between the actuators and the skirt portion therebelow to ensure firm engagement of the bottom end of the skirt with the ground. The resilient suspension between the skirt actuators and the skirt portion accommodates for minor elevation changes in the ground.

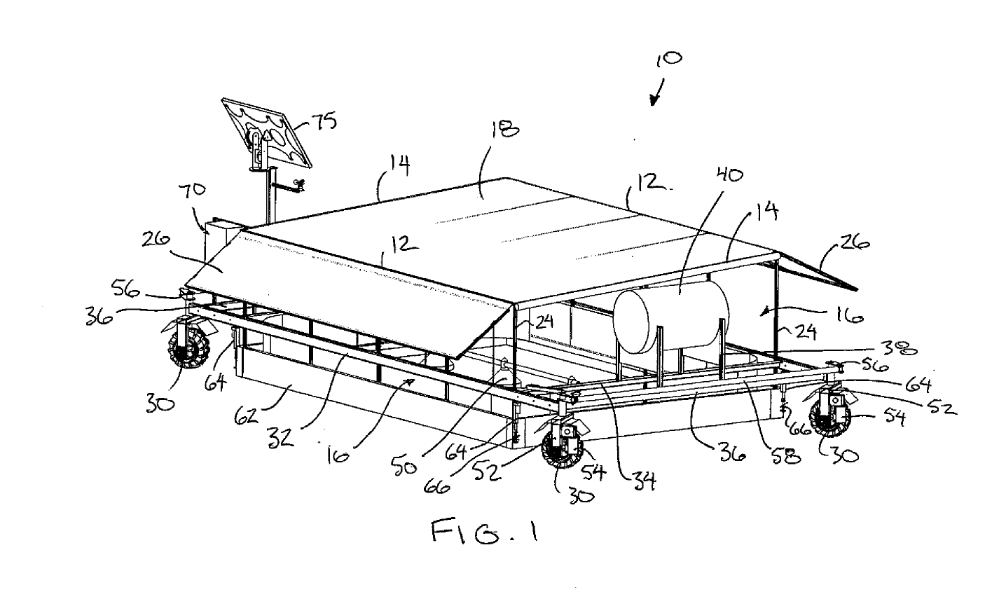

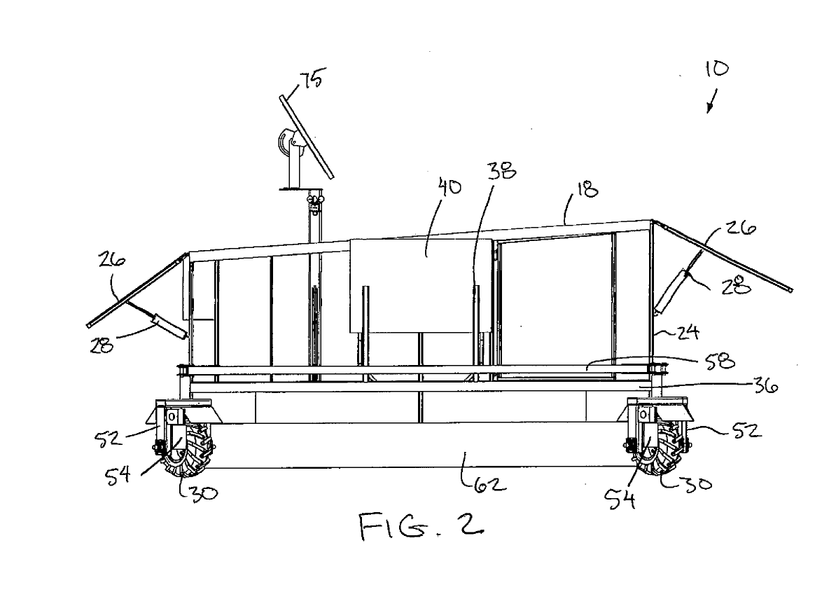

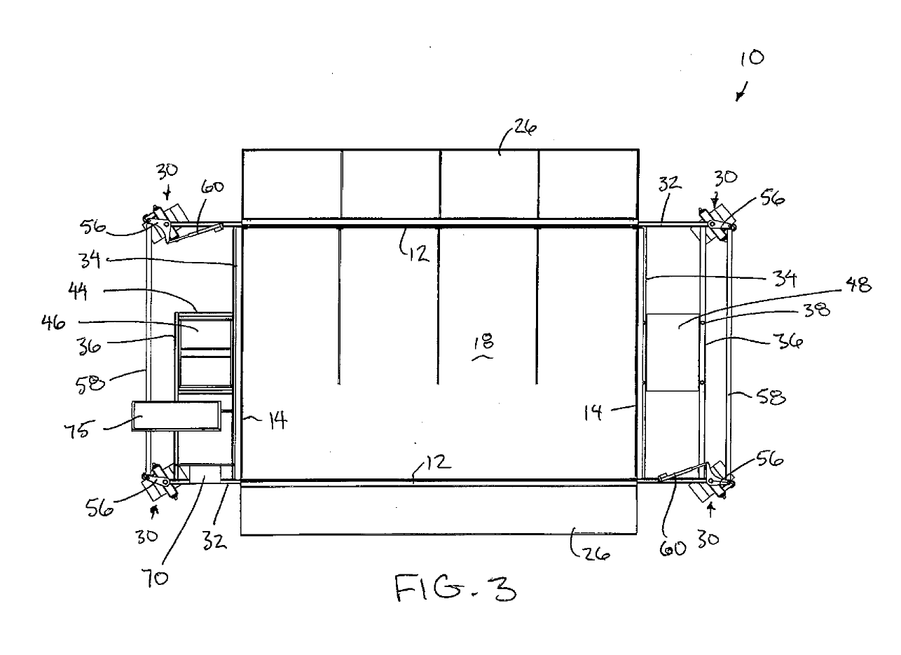

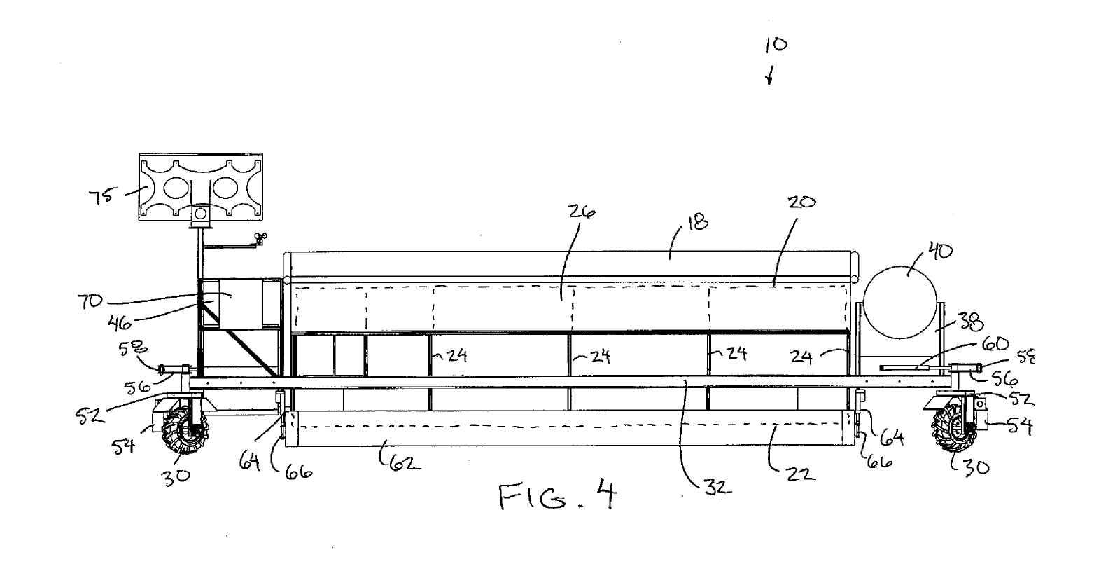

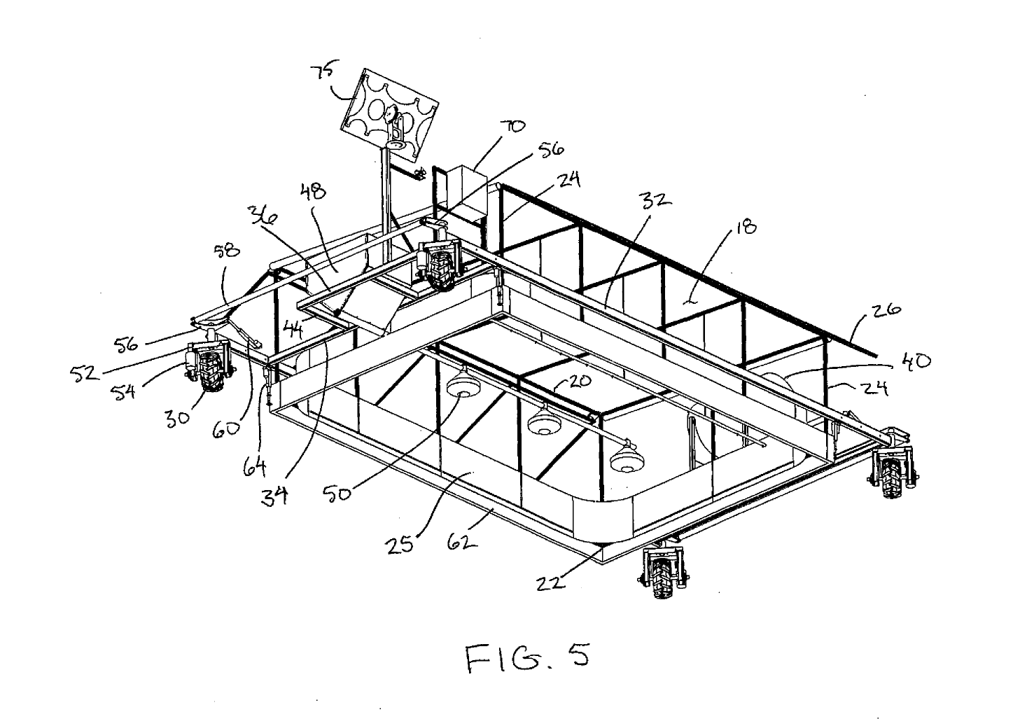

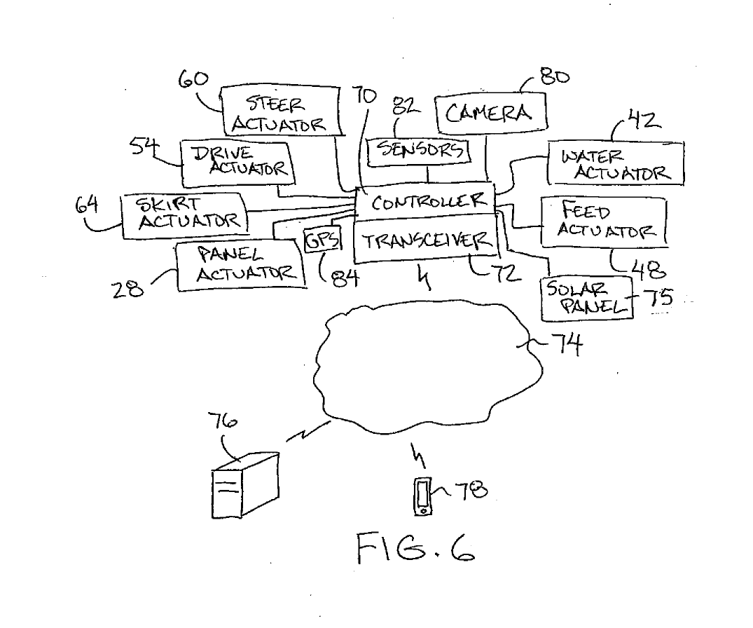

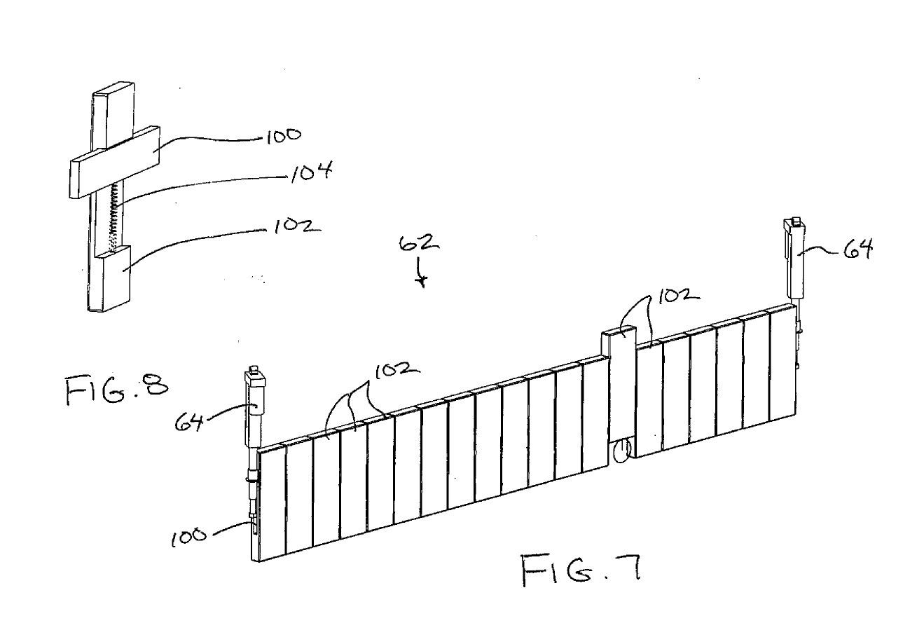

In the illustrated embodiment of FIGS. 1 to 5, the skirt comprises a single rigid wall panel, however in further embodiments, the skirt portion may be provided with a flexible lower portion, or more actuators may be provided to support an overall skirt portion wall which is somewhat flexible to accommodate different ground contours. As shown in FIGS. 7 and 8, the skirt portion 62 in this instance comprises a main rigid beam 100 along each side and end of the perimeter of the frame which is coupled to the skirt actuators for up and down movement relative to the frame, and a plurality of flexible skirt elements 102 resilient mounted relative to the rigid beam 100. Each skirt element 102 is mounted for vertical sliding movement relative to the rigid beam 100 and includes a spring 104 coupled between the skirt element and the beam to bias the skirt element downwardly relative to the beam. As the beam 100 is lowered relative to the ground from the transport position to the stationary position of the skirt portion 62, the individual skirt elements are free to deflect upward by different amounts against the biasing of their respective springs 104 to accommodate different contours of the ground.

Turning now more particularly to FIG. 6, the device 10 is provided with a controller 70 which is mounted on the frame and which is coupled to a suitable transceiver 72 for communication over a wireless network 74, for example the Internet or a cellular network, or a combination thereof, with a central server 76. The controller is powered by a solar panel 75 also mounted on the frame.

The skirt portion 62 may also be provided with electric fence wire extending along the exterior side of the skirt portion about the full perimeter of the frame. The electric fence wire acts as a primary protection against larger animals such as larger rodents, foxes, dogs or coyotes. The power supply and operation of the electric fence wire is similar to a conventional electric fence used for containing cattle.

The central server communicates with the network to allow users with personal computing devices 78, for example smartphones and wireless enabled tablets, and computers and the like, to communicate over a wireless network with the central server, for example using a web based interface. Using their personal computer device 78, a user can login to the central server using a user account with a controlled login access to access various data on the central server. In this manner, various data can be communicated from the controller 70 on the frame of the device to the central server 76 for storage in a memory at the central server, and the data can be further communicated from the central server to personal computing devices 78 of the user. Similarly, instructions can be relayed from the personal computing device 78 to the central server, and in turn from the central server to the controller 70 on the frame.

The controller is operatively connected to all of the actuators on the frame of the device in addition to being operatively connected to a video camera 80 mounted on the frame of the device, and a suitable sensor network 82 also mounted on the frame of the device. The camera 80 is oriented to capture a live video stream of the animals within the hollow interior of the enclosure, and/or a live video stream of environmental conditions surrounding the animal shelter device. The video data can be communicated as a live stream to the personal computer device of the user through the wireless network and the central server. The sensor network 82 typically comprises an array of sensors including for example a temperature sensor, a wind sensor, a humidity sensor, a water level sensor, and/or a feed level sensor for sensing temperature, wind speed, humidity, water level, and/or feed level respectively.

In some embodiments, an egg laying box attachment can be mounted on the front of the housing including a mechanism to collect eggs laid by chickens within the enclosure or within a compartment of the enclosure, and a receptacle or tray to retain the collected eggs thereon. An additional camera can be provided which captures images within the laying box attachment to detect the amount of eggs waiting for pick up. The images of the laying box attachment captured by the additional camera can be sent to the central server for viewing on the personal computer device of the user as described above when the user desires to have fresh eggs everyday.

The housing can also be provided with (i) internal work lights inside the housing to illuminate an interior of the enclosure and (ii) external work lights mounted externally on the housing for illuminating an exterior area surrounding the housing and for providing indication of various conditions to the operator. Illumination of the housing is desirable for loading full grown chickens for butcher. Each of the lights may be in the form of a strip of light emitting diodes, and in the instance that the external lights are used for indication the light strips may include numerous different colours of lights which are programmed to illuminate according to different programming to flash, provide steady illumination, or other.

The controller may also be enabled with various short range wireless communication protocols and abilities, for example Bluetooth™. In this instance, when a user approaches the machine, a Bluetooth tethering process begins between the controller and the personal computer device of the user. The controller can then automatically control the external light strips to indicate the level of water, feed and battery in an instant for the user to be aware of the amount remaining using different colours or lighting patterns with the external lights. The outdoor light strip can also be controlled by the controller to act as a waring light when the machine starts to move, or to flash red when an error with one of the operating components of the device has been detected. The user can now see the error from a distance through the led. In additional to being used as a work light, the interior light strips can be independently controlled along different front, rear, left or right side walls of the housing so that the lights strips can be used to illuminate only the side of the housing corresponding to the direction of movement of the device relative to the ground. In this manner, the chickens within the enclosure can be effectively trained to follow the light when the enclosure is displaced along the ground.

The controller 70 is also connected to a suitable GPS device 84 for determining a GPS location of the frame and for relaying the GPS information from the controller to the central server.

In this manner either the controller or the central server may include suitable programming thereon to actuate the wheel actuators for periodically driving the wheels to displace the frame across the ground to a different prescribed location. The controller may include a timer such that the frame is driven across the ground at scheduled times and for a scheduled duration, or alternatively the controller may displace the frame under instruction from the central server, and/or using GPS information. Steering while displacing the frame across the ground is similarly actuated.

The controller ensures that before displacing the frame across the ground using the wheel actuators, the skirt actuators are always first activated to displace the skirt portion into the transport position. Once the frame has been displaced across the ground to a desired location, the skirt actuators are then again actuated to lower the skirt back to the stationary position.

The controller can displace the body panels of the roof between the open and closed positions thereof according to instructions received by the user through the central server, or optionally in response to a sensed condition by the sensor network. For example, it may be desirable to close the panels in response to high winds or cold temperatures to better protect the animals within the enclosure from the environment.

The controller can be programmed to operate the feed actuator and the water actuator according to a timer or on a schedule, or alternatively the feed and water supply can be actuated to supplement feed delivered to the animals in response to an instruction received from the user through the central server.

The configuration of the controller 70 as described herein allows for instructions for operating any of the actuators to be communicated either from the central server, or from the user with a personal computer device through the central server to the controller 70 to actuate the desired element on the device 10. In addition, feedback from any of the sensors of the sensor network, or the camera can be returned from the controller back through the central server for storage on the central server associated with the respective user account or for relay back to the personal computer device 78 of the user either through a web interface or through various messaging means including text messages, emails, or any other suitable notification means.

The following features are important optional independent features of the invention as described herein:

i) Flaps that open and close on either side of the coop depending on many factors such as interior temperature, conditions outside, sunlight, etc.

ii) A skirt that moves up every time it moves and comes back down once at the final resting spot. As the model shows there is a compression of a spring when it is at its lowest position.

iii) Flashing is provided on the inside of the coop in the form of a strip brush. This strip brush is very flexible therefore leaving the blades of grass to pass through but its opaque and bristle-like features make the chickens believe that there is an actual wall.

iv) The flexible skirt which accommodates rougher terrain operates by the cylinders still pushing the skirt down, but the sections of the skirt are free to slide on a guide that passes through them. The skirt sections are individually spring loaded against this guide.

v) Rounded corners inside the coop to avoid the chickens from crowding when stressed.

vi) An electric wire fence on the outside of the coop alongside the wooden skirt acts as a primary protection against larger animals such as dogs or coyotes.

vii) A double-sided canvas roof and side (black and white) provides flexibility when it comes to trying to maintain a steady ideal temperature inside the coop. The canvas is turned to have the black facing the outside during the colder months of the year (early Spring and late Fall) and the white for the warmer months such as summer.

viii) The movements of the coop are done in such a way that it always makes “square movements”. This way all the moving walls are moving at the same rate decreasing the confusion amongst the chickens.

ix) The system is completely solar powered. The system is designed that only once a week the feed and water need replenishing.

x) An on-board camera provides live camera feed to the app from inside the coop (night vision included). Plans with the camera are to monitor the movement of all the chickens using an image processing tool to be able to decide whether a chicken is dead or alive. If a chicken is dead a notification will be sent through the application or program operating on the personal computer device of the user, thus notifying the farmer. The coop will then wait for the alarm to be cleared before moving again.

xi) The app has access to all the sensor readings such as: In/Out temperatures & humidity; Min/Max daily temperatures & humidity; Current wind; Min/Max wind; Current water level; Current feed level (feed leftover in the bin); Current battery voltage; and Current flap opening.

xii) The app also provides manual control to the farmer such as: He can decide which system is in auto mode (Feed, Flaps, Drive); Direction on front and rear steering system; Control of the front and rear motors; Manual opening and closing of the flaps and skirt; Setting the amount of moves in one direction permissible, and which way to turn to come back on itself; Setting the amount of moves a day (More moves a day when they are older due to the increasing quantity of excrement); and Setting the optimal desired temperature the coop should maintain.

The user can send/receive text messages to the coop. For example, if the user sends an instruction such “Status” by text message to the controller, the controller will respond by forwarding all the most recent sensor readings back to the user device. As a further example, if the user sends an instruction such as “Photo” by text message to the controller, the controller will take a snapshot and send it back to the user.

Preferably the application on the user computer device is configured to be only operable when the user device is within a local network. This prevents unauthorized users from moving the coop. The system may be further configured to “lock” certain parts of the application on the user computer device when not in the vicinity of the coop.

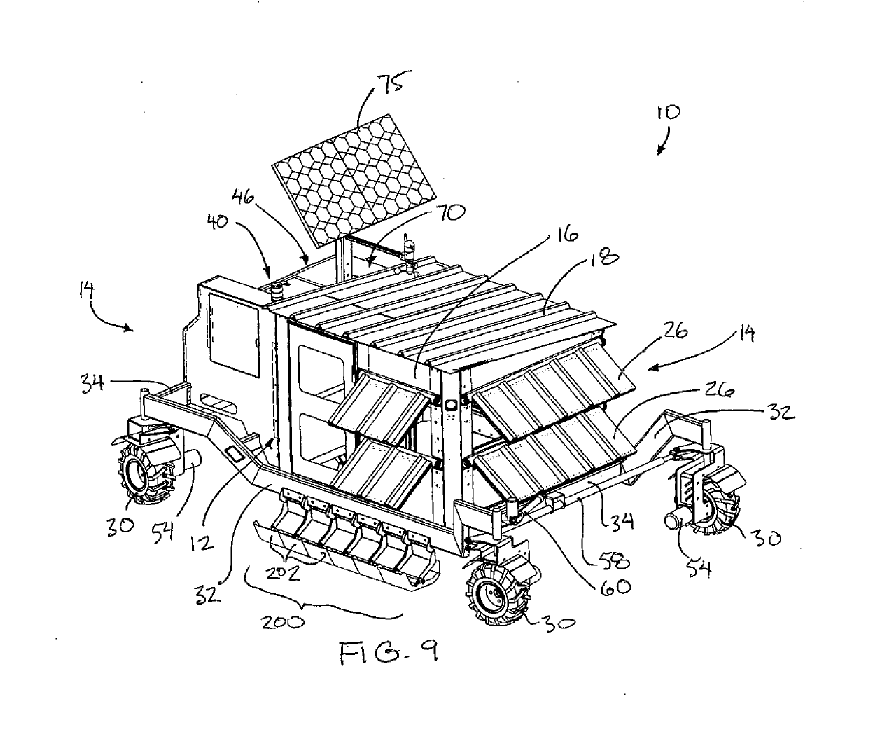

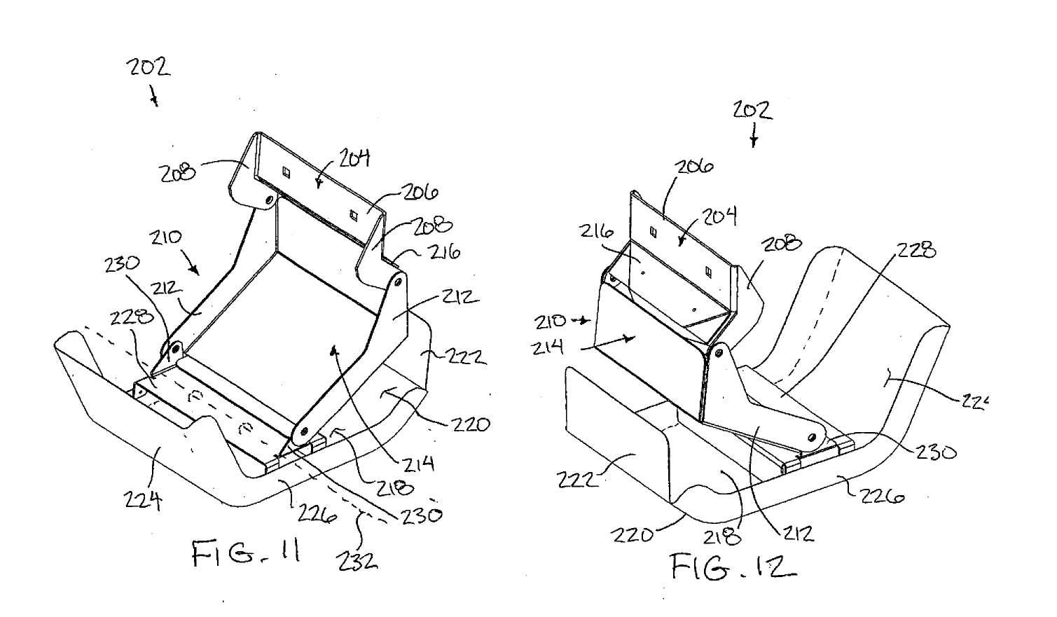

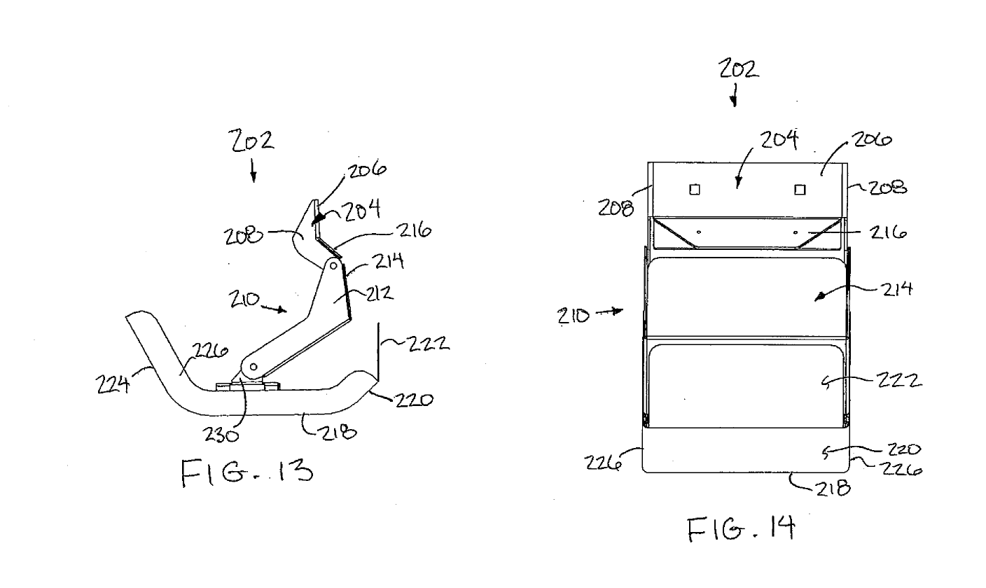

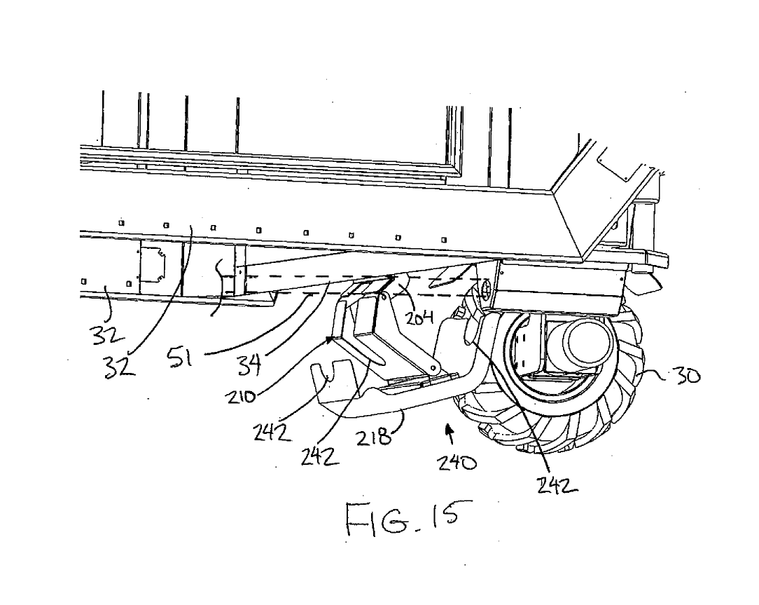

Turning now to FIGS. 9 through 15, there is illustrated a further embodiment of the animal shelter device 10 which is structurally similar and functions in a substantially identical manner to the first embodiment according to FIG. 1. In this instance the device 10 again includes two sides 12 extending longitudinally between two ends 14 with respective wall portions 16 and a roof portion 18 for enclosing a hollow interior which is open to the bottom. The auxiliary body panels 26 in this instance can be open and closed with respective actuators 28 but are instead located at different elevations for pivotal movement relative to respective windows formed in the wall portions rather than being connected to the roof portion.

The main frame of the device 10 again includes longitudinal beams 32 at opposing sides supported on respective wheels 30 at opposing ends thereof with the beams being interconnected by one or more crossbars 34 at front and rear ends, however, the longitudinal beams 32 differ from the first embodiment in that each beam is stepped in profile so as to have an intermediate section which is lower in elevation than opposing end sections which are stepped upwardly over top of the respective wheels 30.

In this embodiment, the water tank 40 and the associated actuator 42 are located at the same end of the main frame as the feed supply tank 46 which again uses a feed auger 51 extending into the hollow interior to respective feed stations similar to the arrangement shown in FIG. 5 in relation to the first embodiment.

In the embodiment of FIG. 9, an additional enclosure is provided about the water tank 40 and the feed supply tank 46, as well as a controller 70 which provides the same functions as described according to the first embodiment. The main frame is driven across the ground also in a similar manner to the first embodiment by use of actuators 54 associated with respective wheels and steering link arms 50 controlled by respective steering actuators 60.

The embodiment of FIG. 9 is most distinguished from the previous embodiment by use of an adjustable skirt portion 200 in place of the skirt portion 62 of the first embodiment. The skirt portion 200 comprises a plurality of skirt elements 202 which each have a lower ground engaging surface defining a respective portion of a bottom end of the lower skirt portion. The lower ground engaging surface of each skirt element is supported for individual displacement relative to the main frame and other skirt elements such that the bottom end of the lower skirt portion 200 is flexible so as to vary in elevation according to varying ground contours.

The skirt elements 202 are provided in rows along each side and along each end of the main frame to form a continuous perimeter about the hollow interior. In this embodiment, crossbars are provided at the front and rear of the intermediate portion of each beam 32 such that the intermediate portions of the beams 32 and the corresponding crossbars at the front and rear ends thereof form a perimeter about the hollow interior at a common horizontal elevation. Each skirt element 202 is mounted at a respective location on the beams and crossbars about the perimeter at the common elevation to be suspended therefrom for engagement with the ground.

Each skirt element includes a mounting member 204 at the top end thereof including an upright mounting plate 206 which is mounted in a parallel orientation against the upright outer surface of the corresponding beam or crossbar of the main frame using fasteners penetrated through respective mounting holes in the mounting plate for fastening to the beam. The mounting member 204 also includes two side plates 208 protruding outwardly and downwardly from opposing ends of the mounting plate at opposing sides of the skirt element to respective bottom ends positioned directly below the respective portion of the main frame to which the mounting member is fastened.

Each skirt element further includes a link member 210 in the form of two side plates 212 which are pivotally coupled to the respective side plates 208 of the mounting member at respective top ends thereof. In the neutral position, the link members extend downwardly at an outward slope to the respective bottom ends thereof. The link member further includes a cover plate 214 including a first portion spanning between the two side plates at the innermost side edges thereof such that the first portion is directly below the inside of the corresponding beam or crossbar of the main frame in the neutral position. A second portion of the cover plate is sloped downwardly and outwardly from the bottom edge of the first portion between corresponding inner edges of the two side plates when the first portion is in the neutral position.

A cover plate 216 is also provided on the mounting member to span between the two side plates 208 along respective inner edges of the side plates which protrude below the corresponding beam or crossbar of the main frame upon which the mounting member is fastened. The cover plate 216 substantially closes the gap between the main frame and the cover plate 216 of the link member.

Each skirt member further includes a skid plate 218 pivotally coupled to the bottom end of the side plates and having a flat bottom so as to define the Lower ground engaging surface of the skirt member.

A ramp plate 220 is sloped upwardly and inwardly from an inner edge of the skin plate with a curved transition between the ramp plate and the flat bottom of the skid plate so that the inside edge of the skid plate can readily ride over small bumps in the ground. An inner wall portion 222 is provided as an upright plate oriented perpendicularly to the flat bottom of the skid plate to extend upwardly from the upper inner edge of the ramp plate. In the neutral position of the skirt element from which the skid plate can be deflected upwardly or downwardly relative to the main frame, the inner wall portion 222 is intended to be substantially parallel to an inner surface of the corresponding beam or crossbar supporting the skirt element thereon at a location which is inwardly towards the interior of the main frame relative to said inner surface of the beam or crossbar.

A ramp plate 224 is similarly provided at the outer edge of the skid plate to extend outwardly at an upward slope therefrom to a top edge which is similar in elevation to the top edge of the inner wall 222. A curved transition is formed between the ramp plate and the 10 flat bottom of the skid plate such that the outer edge of the skid plate is also readily adapted to ride over small bumps in the ground.

Opposing sides of the skid plate are provided with side plates 226 which extend upwardly from opposing side edges of the skid plate so as to be perpendicular to the flat bottom thereof. The side plates are thus suited to be parallel to the corresponding side plates of adjacent skirt elements and are position to be in close proximity to the corresponding side plates of the adjacent skirt elements in a mounted position on the main frame. A curved transition is provided between the side plates in the flat bottom having a smaller radius of curvature than the inner and outer edges so as to provide some ability to ride over bumps in the ground, while minimizing gaps between adjacent ones of the skirt elements through which vermin can enter into the hollow interior of the device.

A cross brace 228 is provided on each skid plate to span laterally between the opposing side plates 226 at an intermediate location spaced from both inner end outer edges of the flat bottom, but at a location which is closer to the outer edge than the inner edge. Mounting tabs 230 protrude upwardly from opposing ends of the cross brace to define respective pivot locations which are pivotally coupled to the bottom ends of the side plates 212 forming the link member 210. The slope of the link member in the neutral position ensures that most of the plate lies under the link member with the inner edge of the skate plate being substantially aligned in a common vertical plane with the inner surface of the corresponding beam or crossmember supporting the skirt element thereon or spaced only slightly inwardly therefrom.

The skid plate is pivotal about a horizontal axis oriented in the longitudinal direction of the beam or crossbar upon which the skirt element is supported relative to the link member and the main frame as defined by the pivotal connection between the tabs of the cross brace 228 and the bottom end of the link member such that in angular orientation of the skate plate can be varied about said axis to best accommodate ground contours.

Turning now to FIG. 15, one of the skirt elements 202 comprises an auxiliary element 240 which is substantially identical to the elements 202 except for some additional cut-out openings 242 provided at various locations to accommodate the feed auger 51. More particularly, the cut-out openings 242 are provided as slots which are open to the top edge within the inner wall portions 222, within the outer ramp plate 224 and within the cover plate 214 of the link member 210 respectively. Furthermore, an additional cut-out opening is provided in the cover plate 216 of the mounting member 204 which is open to the bottom edge. Each of the cut-out openings has a width substantially equal to or greater than the diameter of the feed auger 51, and a height which is sufficient to ensure little or no interference between the skirt element 240 and the feed auger 51 throughout the full range of motion of the skirt element relative to the main frame.

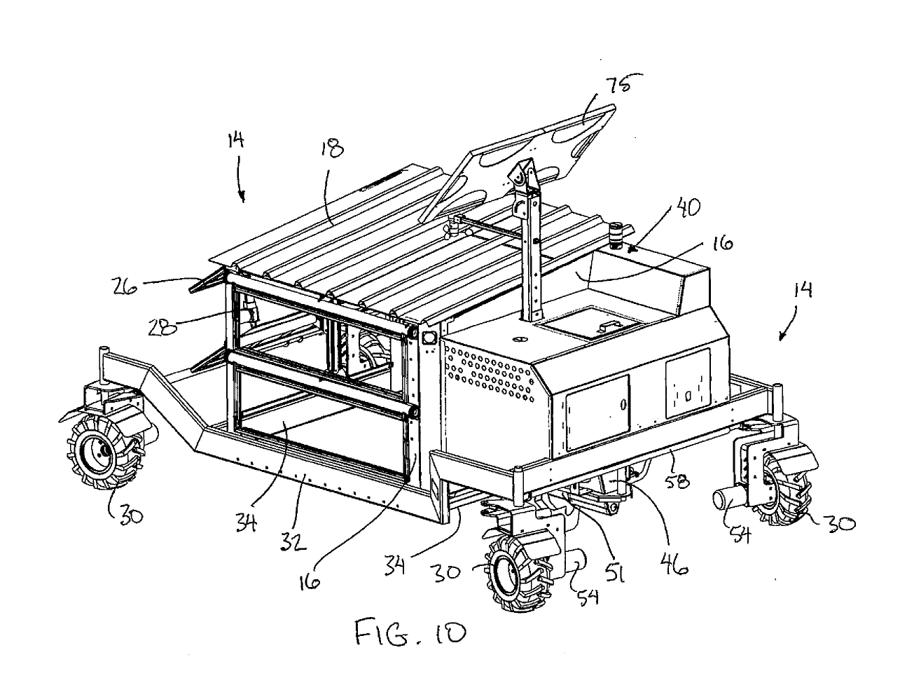

A flexible member 232, for example a rope or cable, may be connected between each of the skirt elements, for example at the link member, or at a portion of the skid plate as shown in broken line in FIG. 11. The flexible member may be provided as a continuous member spanning a plurality of adjacent skirt elements, or may be provided as individual sections connected between adjacent ones within a pair of skirt elements.

In either instance the flexible member may be resilient, or may be provided with slack between adjacent skirt elements. In this manner, each skid plate is free to change in elevation initially independently relative to adjacent skid plates, by either taking up the slack in the flexible member, or stretching the resilient flexible member. Any further change in elevation of the skid plate beyond the initial independent movement though would then cause the skid plates of adjacent skirt members to follow and also result in a corresponding deflection thereof relative to the main frame once the slack or the elasticity of the flexible member is taken up. Accordingly, any large change in elevation of a skid plate will tension the flexible member to also deflect adjacent skid plates upwardly as well by a smaller amount.

In some embodiments, the connecting flexible member itself may be electrified to assist in keeping vermin out of the hollow interior of the device. Alternatively, an auxiliary cable may be provided about the perimeter of the hollow interior for connection to each of the skirt elements to provide an electrified barrier independent of the flexible member which causes the movement of individual skirt elements to cause corresponding movements of other skirt elements.

The skid plate may be formed of a different material than the link member and the mounting member within each skirt element. For example, one of the skid plate, the link member, or the mounting member may comprise an electrically insulated material such as plastic so as to electrically isolate the electrified barrier from the remainder of the device.

Furthermore, the skid plate may be formed of a different material so as to be better suited to protect against wear, or so as to be better suited for ready replacement when worn. For example, the skate plate may have a plastic or ceramic coating over top of a metal plate or may be formed of a different metal than the remainder of the skirt element depending upon desired wear characteristics.

In typical embodiments, the skid plates are biased downwardly into engagement with the ground relative to the main frame simply by gravity acting on the weight of the skid plates. In addition to being biased downwardly by gravity relative to the main frame, additional springs may be provided which are mounted between the link member and the mounting member, between the link member and the skid plate, or between the mounting member and the skid plate to provide further downward biasing of the skid plate against the ground. The springs may comprise springs mounted for linear compression and extension, or helical springs incorporated into one of the pivotal hinges so as to undergo torsional deflection, between the link member and the mounting member for example.

By supporting the skid plates at the bottom of each skirt element using a link member oriented at a slope, free pivotal movement of the link member relative to the main frame enables the height of the flat bottom of the skid plate to be adjusted in elevation relative to the main frame, and the free pivotal movement of the skid plate relative to the link member enables the angular orientation of the skid plate to be adjusted relative to the main frame so that the flat bottom of the skid plates about the entire skirt portion 200 closely follow the contours of the ground at different locations of the device across a field to maintain an adequate barrier that prevents escape of the animals contained in the device while also preventing the entry of undesirable pests or animals from the exterior into the device. The neutral position corresponds to a common elevation of all of the skid plates when the device is supported on level ground. Any dips in elevation relative to level ground enable downward deflection of the skid plates from the neutral position, and any raised bumps in elevation in the ground relative to level ground enable upward deflection of the skid plates from the neutral position.

Typically, a lift assembly is provided for commonly lifting all of the skirt elements relative to the main frame into a transport position in which each of the skirt elements is spaced above the ground for transport of the device over any significant distance. The skirt elements remain engaged with the ground when displacing the device over small distances with animals contained therein.

When a flexible member is provided which interconnects between all of the skirt elements, the lift assembly may include lifting elements which lift the flexible member at a plurality of designated lifting locations about the perimeter of the device so that collectively lifting the flexible member from the plurality of designated lifting locations will effectively lift all skirt elements.

Alternatively, all of the skirt elements may have their mounting members secured to a perimeter support frame assembly which is adjustable in height relative to the main frame between a working position which supports the skirt elements substantially engaged with the ground at their respective neutral positions on horizontal ground and a transport position which supports the skirt elements raised upwardly relative to the frame to a height which is greater than the height of the skirt elements in the working position. The lift assembly in this instance is coupled between the main frame portion and the perimeter support frame assembly.

Since various modifications can be made in my invention as herein above described, it is intended that all matter contained in the accompanying specification shall be interpreted as illustrative only and not in a limiting sense.

1. A mobile animal shelter device for movement across a ground surface, the device comprising:
a frame defining an enclosure having walls and a roof surrounding a hollow interior of the enclosure which is arranged for containing animals therein, and an open bottom such that the hollow interior of the enclosure is open to the ground surface;
a plurality of transport wheels supporting the frame thereon such that the frame is supported for rolling movement across the ground surface;
a motor operatively connected to the transport wheels for driving the transport wheels; and
a controller operatively connected to the motor so as to be arranged to displace the frame across the ground surface by a controlled amount prescribed by the controller.

2. The device according to claim 1 wherein the controller includes a timer configured to actuate the motor at selected times for a controlled duration to effect movement of the frame across the ground surface by said controlled amount.

3. The device according to claim 1 wherein the controller includes a GPS device in communication with the controller such that the controller is configured to effect movement of the frame across the ground surface by said controlled amount using GPS information from the GPS device.

4. The device according to claim 1 wherein the transport wheels are steerable about respective upright axes relative to the frame and wherein there is provided a steering actuator arranged to steer the transport wheels relative to the frame about their respective upright axes, the controller being operatively connected to the steering actuator so as to be arranged to steer the transport wheels by a controlled amount as the frame is displaced across the ground surface.

5. The device according to claim 1 further comprising a central server at a remote location relative to the device, the controller including a transceiver adapted to communicate with the central server over a wireless network such that the controller is operable to displace the frame across the ground by said controlled about in response to an instruction received from the central server.

6. The device according to claim 5 further comprising a personal computer device adapted to communicate with the central server over a wireless network such that the computer device is arranged to receive feedback information from the controller through the central server and the controller is arranged to receive instructions from the computer device through the central server.

7. The device according to claim 6 wherein the feedback information includes a water level sensed by a water dispenser sensor on the frame, a feed level sensed by a feeder sensor on the frame, a humidity level sensed by a humidity sensor on the frame, a temperature sensed by a temperature sensor on the frame, a wind speed sensed by a wind sensor on the frame, or a video captured by a camera on the frame.

8. The device according to claim 1 further comprising:
at least one body panel which is pivotally supported on the frame so as to be operable between a closed position covering a respective boundary portion of the enclosure and an open position in which the respective boundary portion is at least partially unobstructed by the body panel; and
a panel actuator connected to said at least one body panel;
the controller being operatively connected to the panel actuator so as to be arranged to actuate opening and closing of said at least one body panel.

9. The device according to claim 8 wherein the controller is arranged to displace said at least one body panel responsive to a sensed environmental condition as sensed by a sensor on the frame.

10. The device according to claim 8 further comprising a central server at a remote location relative to the device, the controller including a transceiver adapted to communicate with the central server over a wireless network such that the controller is arranged to displace said at least one body panel responsive to an instruction received by the controller from the central server over the wireless network.

11. The device according to claim 1 wherein there is provided a feed supply and a feeder supported on the frame, the controller being operatively connected to the feeder so as to be arranged to dispense a controlled amount of feed from the feed supply into the enclosure.

12. The device according to claim 1 further comprising a lower skirt portion supported at a bottom end of the walls of the frame to extend fully about a perimeter of the frame, the lower skirt portion being movable relative to the transport wheels between a transport position in which the skirt portion is spaced above the ground surface and a stationary position in which the skirt portion is engaged with the ground surface.

13. The device according to claim 12 wherein the frame is fixed in elevation relative to the transport wheels and the skirt portion is movable relative to the frame between the transport position and the stationary position.

14. The device according to claim 13 further comprising a plurality of skirt actuators coupled between the frame and the skirt portion at spaced apart positions about the perimeter of frame, the skirt actuators being operatively connected to the controller so as to be operable to displace the skirt portion between the transport and stationary positions under control of the controller.

15. (canceled)

16. (canceled)

17. (canceled)

18. A mobile animal shelter device for movement across a ground surface, the device comprising:
a frame defining an enclosure having walls and a roof surrounding a hollow interior of the enclosure which is arranged for containing animals therein, and an open bottom such that the hollow interior of the enclosure is open to the ground surface;
a plurality of transport wheels supporting the frame thereon such that the frame is supported for rolling movement across the ground surface;
a motor operatively connected to the transport wheels for driving the transport wheels;
at least one body panel which is pivotally supported on the frame so as to be operable between a closed position covering a respective boundary portion of the enclosure and an open position in which the respective boundary portion is at least partially unobstructed by the body panel;
a panel actuator connected to said at least one body panel; and
a controller operatively connected to the panel actuator so as to be arranged to actuate opening and closing of said at least one body panel.

19. (canceled)

20. (canceled)

21. The device according to claim 1 further comprising:
a lower skirt portion supported at a bottom end of the walls of the main frame to extend downwardly to a bottom end of the lower skirt portion for engaging the ground about a full perimeter of the main frame;
the lower skirt portion comprising a plurality of skirt elements, each having a lower ground engaging surface defining a respective portion of the bottom end of the lower skirt portion and being supported for individual displacement relative to the main frame such that the bottom end of the lower skirt portion is flexible so as to vary in elevational according to ground contours.

22. The device according to claim 21 wherein each skirt element is biased downwardly for engagement against the ground by a spring biasing member.

23. (canceled)

24. The device according to claim 21 wherein each skirt element comprises a skid plate defining the lower ground engaging surface for engagement against the ground, wherein the skid plate includes a ramp surface protruding outwardly from opposing edges of the skid plate at an upward slope, wherein each skirt element includes a linkage coupled between the skid plate and the main frame for supporting the skid plate to vary in elevational relative the main frame, and wherein the skid plate is pivotal relative to the linkage about a generally horizontal axis.

25. (canceled)

26. (canceled)

27. The device according to claim 21 wherein each skirt element comprising a linkage member pivotally supported at a top end relative to the main frame and extending downwardly at a slope to a bottom end supporting the lower ground engaging surface therein such that pivotal movement of the linkage member varies an elevation of the lower ground engaging surface relative to the main frame.

28-30. (canceled)

31. A mobile animal shelter device for movement across a ground surface, the device comprising:
a frame defining an enclosure having walls and a roof surrounding a hollow interior of the enclosure which is arranged for containing animals therein, and an open bottom such that the hollow interior of the enclosure is open to the ground surface;
a plurality of transport wheels supporting the frame thereon such that the frame is supported for rolling movement across the ground surface;
a motor operatively connected to the transport wheels for driving the transport wheels;
at least one body panel which is pivotally supported on the frame so as to be operable between a closed position covering a respective boundary portion of the enclosure and an open position in which the respective boundary portion is at least partially unobstructed by the body panel;
a panel actuator connected to said at least one body panel; and
a controller operatively connected to the panel actuator so as to be arranged to actuate opening and closing of said at least one body panel.
